(19) United States
(12) Patent Application Publication
(10) Pub. No.: US 2007/0136161 A1
(43) Pub. Date: Jun. 14, 2007

(54) Method for funding establishment and operation of a trauma center

(76) Inventor: Richard W. Charette, Las Vegas, NV (US)

Correspondence Address: WEISS & MOY PC, 4204 NORTH BROWN AVENUE, SCOTTSDALE, AZ, 85251, US

(21) Appl. No.: 11/293,422

(22) Filed: Dec. 5, 2005

(51) Int. Cl. G06Q 40/00

(52) U.S. Cl. 705/35

(57) ABSTRACT

A method for securing funding for at least one of the establishment and operation of a Level I or Level II trauma center. A community in which a trauma center is to be established and/or maintained is identified. In addition, a plurality of local businesses in the community that may be capable of paying for advertising services within the trauma center are identified. Funds are solicited from the plurality of local businesses, in exchange for at least one specified advertising opportunity within the confines of the trauma center. In embodiment, the local businesses pay a periodic fee for the periodic maintenance of an advertisement within the trauma center.

### FIELD OF THE INVENTION

The present invention relates to trauma centers and, more particularly, to a method for securing funding to establish and/or maintain a trauma center within a community.

### BACKGROUND OF THE INVENTION

Trauma centers are specialized medical facilities having the capacity of dealing effectively with traumatic injuries. The American College of Surgeons has established recommendations for the accreditation of trauma centers. Consistent with these recommendations, there are generally three levels of trauma centers—Levels I, II, and III.

A Level III trauma center is basically a 24-hour emergency room that has designated trauma teams, on call professionals, and is capable of transferring patients to a higher level of care. The requirements for Level I and II trauma centers are considerably higher.

For example, a Level I center should have, among other things, (a) an in-house, qualified, trauma surgeon, radiologist, emergency physician, and anesthesiologist; (b) 24 hour CT availability; (c) 24 hour equipped and staffed operating suite; (d) backup and equipped surgical suite; (e) trauma intensive care facilities for adult and pediatric patients; (f) a trained trauma team, including trained trauma nurses; (g) dedicated resuscitation suites (to manage two simultaneously multi-system injured patients); (h) 24 hour laboratory facilities; (i) protocol for in house burn care Rehabilitation facilities; (j) helicopter landing pad; and (k) pediatric resuscitation facilities, personnel, and intensive care units.

Level II facilities generally meet all Level I requirements, but are not required to have neurosurgeons/trauma surgeons in house, or to handle pediatric trauma.

Post-9/11, the recognition of the importance of a trauma center to a community has grown. According to a Harris® poll, a majority of Americans believe that having a trauma center is as important, or more important, than having a fire or police department. However, the reality is quite different. According to a 2002 study, there are nearly 5,000 hospitals in the U.S.—but only 190 Level I and 263 Level II trauma centers. The primary barrier to the creation of more Level I and II facilities is money.

There is a need to develop new and innovative methods of funding the establishment and/or operation of Level I and II trauma centers, so that the number of such facilities many be meaningfully increased. The present invention satisfies this need and provides other, related, advantages.

### SUMMARY OF THE INVENTION

In accordance with one embodiment of the present invention, a method for securing funding for at least one of the establishment and operation of a trauma center is disclosed. The method comprises: identifying a community in which a trauma center is to be at least one of established and maintained; identifying a plurality of local businesses in the community; soliciting funds from the plurality of local business for at least one of the establishment and maintenance of a trauma center; wherein, in exchange for the funds, the plurality of local businesses are provided at least one specified advertising opportunity within the confines of the trauma center.

In accordance with another embodiment of the present invention, a method for securing funding for at least one of the establishment and operation of a trauma center is disclosed. The method comprises: identifying a community in which a trauma center is to be at least one of established and maintained; identifying a plurality of local businesses in the community; soliciting funds from the plurality of local business for at least one of the establishment and maintenance of a trauma center; wherein, in exchange for the funds, the plurality of local businesses are provided at least one specified advertising opportunity within the confines of the trauma center; wherein the at least one specified advertising opportunity include at least one of the advertisement of a company name and/or logo including on the outside of one or more trauma center buildings, on interior walls, within a waiting area, within a treatment area and on a commercial running on a hospital television set; and seeking periodic payments from the plurality of local businesses for the right to continue to utilize the at least one specified advertising opportunity.

In accordance with another embodiment of the present invention, a method for securing funding for at least one of the establishment and operation of a trauma center is disclosed. The method comprises: identifying a community in which a trauma center is to be at least one of established and maintained; identifying a plurality of local businesses in the community; wherein the plurality of local business includes at least one hotel; wherein the at least one hotel includes at least one hotel having a casino; soliciting funds from the plurality of local business for at least one of the establishment and maintenance of a trauma center; wherein, in exchange for the funds, the plurality of local businesses are provided at least one specified advertising opportunity within the confines of the trauma center; wherein the at least one specified advertising opportunity include at least one of the advertisement of a company name and/or logo including on the outside of one or more trauma center building, on interior walls, within a waiting area, within a treatment area, and on a commercial running on a hospital television set; seeking periodic payment from the plurality of local businesses for the right to continue to utilize the at least one specified advertising opportunity; and receiving periodic payments from the plurality of local businesses for the right to continue to utilize the at least one specified advertising opportunity.

### BRIEF DESCRIPTION OF THE DRAWINGS

FIG. 1 is a flow chart, illustrating a method consistent with an embodiment of the, present invention.

### DETAILED DESCRIPTION OF THE PREFERRED EMBODIMENTS

In accordance with one embodiment of the present invention, a first step consists of identifying a community in which a new trauma center is to be established, or in which an existing trauma center is to be further funded, using monies secured at least in part from the method of the present invention,

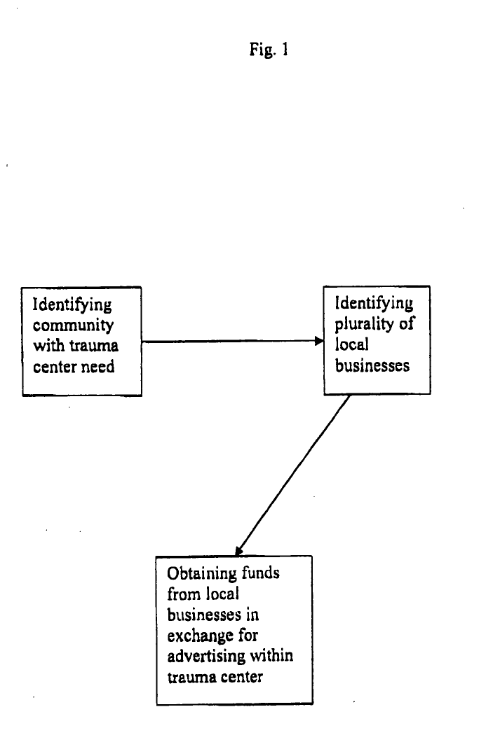

Referring to FIG. 1, in accordance with one embodiment of the present invention, another step involves the identification of a plurality of local businesses that are active in the local economy, in which the trauma center is to be placed. The identified entities should have sufficient financial strength to be able to meaningfully provide funds to the establishment and/or operation of a trauma center. Moreover, they should be sufficiently large so that their ability to grow—through the ability to increase customers and/or the ability to attract more qualified employees—may be directly affected by the establishment of a Level I or II trauma center in the local community.

For example, in the city of Las Vegas, hotels and casinos are a critically important part of the local economy. The continued operation of a Level I or II trauma center in Las Vegas can help keep the local tourism business thriving, increasing the profits of the local hospitality providers and making it easier for them to retain skilled employees who may want to make sure that their city of residence has especially good medical facilities.

Of course, the types of local businesses that may be candidate funding sources for a trauma center may change from community to community. For example, in parts of Northern California, the technology sector may provide the best source for such funding.

An additional step involves the solicitation of a plurality of these entities, for funds for establishment and/or operation of a trauma center. This should not be simply an ordinary, charitable solicitation. Instead, the solicitation should very expressly incorporate an advertising component for the local commercial contributors. This may include the advertisement of a company name and/or logo within the trauma center, including on the outside of one or more trauma center buildings, on interior walls, within waiting and/or treatment areas, on commercials appearing on hospital television sets, etc. Indeed, the overall naming rights for a trauma center could be placed up for sale.

Preferably, prior to such solicitation, marker research should be undertaken, to determine for example traffic levels through the trauma center, patient demographics, and similar data that would be relevant to an entity considering the expenditure of funds on marketing. This would be part of a process of, as much as possible, making the solicitation of funds for a trauma center a straight, commercial, advertising transaction, rather than an act of charity.

In this regard, it may be desired to utilize a more advertising-specific model, so that payments are made on a periodic, rather than one-time basis. For example, an entity may purchase the right to place advertisements in a waiting room for a one month period, with the need to pay separately for each additional month in the event that the entity wished to continue the advertisements. This would be in contrast to a traditional, charity model, wherein there would generally not be an obligation to pay periodically in order to maintain the presence of the donor's name on a wall or the like.

The entity soliciting the funds from the local businesses may be non-profit or, alternatively, for profit.

The term “trauma center” as used herein means a Level I or II trauma center, or its equivalent.

While the invention has been particularly shown and described with reference to preferred embodiments thereof, it will be understood by those skilled in the art that the foregoing and other changes in form and details may be made therein without departing from the spirit and scope of the invention.

I claim:

1. A method for securing funding for at least one of the establishment and operation of a trauma center comprising;
identifying a community in which a trauma center is to be at least one of established and maintained;
identifying a plurality of local businesses in the community;
soliciting funds from the plurality of local business for at least one of the establishment and maintenance of a trauma center;
wherein, in exchange for the funds, the plurality of local businesses are provided at least one specified advertising opportunity within the confines of the trauma center.

2. The method of claim 1 wherein the plurality of local business includes at least one hotel.

3. The method of claim 2 wherein the at least one hotel includes at least one hotel having a casino.

4. The method of claim 1 wherein the specified advertising opportunities include at least one of the advertisement of a company name and/or logo including on the outside of one or more trauma center buildings, on interior walls, within a waiting area, within a treatment area, and on a commercial running on a hospital television set.

5. The method of claim 1 in which the soliciting step further comprises seeking periodic payments from the plurality of local businesses for the right to continue to utilize the at least one specified advertising opportunity.

6. The method of claim 5 further comprising the step of receiving periodic payments from the plurality of local businesses for the right to continue to utilize the at least one specified advertising opportunity.

7. The method of claim 1 wherein the at least one specified advertising opportunity includes the right to display a corporate logo.

8. A method for securing funding for at least one of the establishment and operation of a trauma center comprising:
identifying a community in which a trauma center is to be at least one of established and maintained;
identifying a plurality of local businesses in the community;
soliciting funds from the plurality of local business for at least one of the establishment and maintenance of a trauma center;
wherein, in exchange for the funds, the plurality of local businesses are provided at least one specified advertising opportunity within the confines of the trauma center;
wherein the at least one specified advertising opportunity include at least one of the advertisement of a company name and/or logo including on the outside of one or more trauma center buildings, on interior walls, within a waiting area, within a treatment area, and on a commercial running on a hospital television set; and
seeking periodic payments from the plurality of local businesses for the right to continue to utilize the at least one specified advertising opportunity.

9. The method of claim 8 wherein the plurality of local business includes at least one hotel.

10. The method of claim 9 wherein the at least one hotel includes at least one hotel having a casino.

11. The method of claim 8 further comprising the step of receiving periodic payments from the plurality of local businesses for the right to continue to utilize the at least one specified advertising opportunity.

12. The method of claim 8 wherein the at least one specified advertising opportunity includes this right to display a corporate logo.

13. A method for securing funding for at least one of the establishment and operation of a trauma center comprising:
identifying a community in which a trauma center is to be at least one of established and maintained;
identifying a plurality of local businesses in the community;
wherein the plurality of local business includes at least one hotel;
wherein the at least one hotel Includes at least one hotel having a casino;
soliciting funds from the plurality of local business for at least one of the establishment and maintenance of a trauma center;
wherein, in exchange for the funds, the plurality of local businesses are provided at least one specified advertising opportunity within the confines of the trauma center;
wherein the at least one specified advertising opportunity include at least one of the advertisement of a company name and/or logo including on the outside of one or more trauma center buildings, on interior walls, within a waiting area, within a treatment area, and on a commercial running on a hospital television set;
seeking periodic payments from the plurality of local businesses for the right to continue to utilize the at least one specified advertising opportunity; and
receiving periodic payments from the plurality of local businesses for the right to continue to utilize the at least one specified advertising opportunity.

14. The method of claim 13 wherein the at least one specified advertising opportunity includes the right to display a corporate logo.
